(19) United States
(12) Patent Application Publication
(10) Pub. No.: US 2014/0140086 A1
(43) Pub. Date: May 22, 2014

(54) VEHICLE INTERIOR LIGHTING

(71) Applicant: Yazaki Corporation, Tokyo (JP)

(72) Inventors: Shingo CHIBA, Makinohara-shi (JP); Takashi WAKASUGI, Makinohara-shi (JP); Shogo SUZUKI, Makinohara-shi (JP)

(73) Assignee: Yazaki Corporation, Tokyo (JP)

(21) Appl. No.: 14/166,236

(22) Filed: Jan. 28, 2014

Related U.S. Application Data
(63) Continuation of application No. PCT/JP2012/070133, filed on Aug. 1, 2012.

(30) Foreign Application Priority Data
Aug. 2, 2011 (JP) 2011-169566

(51) Int. Cl. B60Q 1/00

(52) U.S. Cl. CPC B60Q 1/0005
USPC 362/548

(57) ABSTRACT

A vehicle interior lighting to be attached into a lamp attaching hole formed in a door trim of a vehicle has a design portion placed on a passenger compartment side of the door trim and a function portion that is placed on an outdoor side of the door trim and that is to be attached into the lamp attaching hole. The function portion has a housing that has an opening opened to the passenger compartment side, and a light source accommodation portion for accommodating and holding a bulb and a light source protective portion that provided with the housing so as to cover the opening and has a light passing aperture of size to prevent the light source from contacting an external member.

### CROSS REFERENCE TO RELATED APPLICATIONS

This application is a continuation of PCT application No. PCT/JP2012/070133, which was filed on Aug. 1, 2012 based on Japanese Patent Application (No. 2011-169566) filed on Aug. 2, 2011, the contents of which are incorporated herein by reference.

### BACKGROUND OF THE INVENTION

1. Field of the Invention

The present invention relates to a vehicle interior lighting.

2. Description of the Related Art

In some cases, a vehicle has been equipped with an interior lighting disposed close to a front window on a ceiling. The interior lighting is disposed separately from a dome lamp positioned substantially at a center of the ceiling, and a bulb (an electric bulb) adopting a filament is often used as a light source of the interior lighting. A sun visor for shielding backlight equipped with a vanity mirror that is a compact cosmetic mirror, has also been known heretofore. However, in order to enable use of the vanity mirror in the night time, an interior lighting has recently been disposed in the neighborhood of the vanity mirror, and a sun visor having a cover that reclosably covers the vanity mirror has also come into widespread use. Especially, the vanity mirror tends to be heavily used in high-value-added high grade vehicles, convertible-type passenger automobiles that cannot be structurally equipped with a passenger compartment lamp, and others.

As instance, as shown in FIG. 10A, a vehicle interior lighting 501 has a design portion 511 made by fixing a lens 509 to a housing 507 that can be attached to an opening 505 of an interior wall member 503, such as a ceiling surface acting as a portion of a vehicle on which the material is to be mounted; a light source (a filament) 513 that emits light in predetermined chromaticity; and a function portion 515 that is supported by the design portion 511 and that is to be placed on a back side of the interior wall member 503. The function portion 515 can be integrally assembled into the design portion 511.

The vehicle interior lighting 501 is assembled at a factory; is transported as a single unit to a vehicle to which the lighting is to be attached; and is attached to the interior wall member 503 of a vehicle. There is possibility in that the light source 513 may be damaged by a physical shock from an external member during transport of the vehicle interior lighting 501. For this reason, in a known vehicle interior lighting, the design portion 511 and the function portion 515 are kept separate from each other and left unassembled before being transported. As shown in FIG. 10B, the light source 513 equipped with the function portion 515 is covered with a dedicated light source protective cover 517, thereby taking measures to protect the light source.

However, the light source protective cover 517 is supposed to be removed after being transported because it is too large when the function portion 515 is assembled into the design portion 511 in an integrated fashion, posing impediments to assembly operation. For this reason, the vehicle interior lighting 501 is attached to the opening 505 of the interior wall member 503 of the vehicle while the fragile light source 513 remains exposed while being laid bare outside. Accordingly, there is possibility in that the light source 513 may be damaged on contact with something, or the light source 513 may be damaged by water droplets from above, like the ceiling, or a buildup of dust.

Consequently, proposed in PTL 1 and PTL 2 are vehicle interior lightings that prevent infliction of such damage to a light source, which would otherwise be caused during transport, and that can protect the light source after being attached to an interior surface in a vehicle.

For these reasons, proposed in PTL 1 and PTL 2 are vehicle interior lightings, each of which includes a function portion which houses a light source and to which a cover for protecting the light source is removably attached, and a design portion that has a housing to which the function portion is to be attached and which is attached to an opening of an interior wall member. The function portion with the cover and the design portion are assembled together, whereby the function portion and the design portion are integrally attached to the opening of the interior wall member.

### CITATION LIST

### Patent Literature

[PTL 1] JP-A-2010-179837
[PTL 2] JP-A-2010-173593

### SUMMARY OF THE INVENTION

The cover of the vehicle interior lighting described in PTL 1 is formed in a substantially semi-cylindrical shape that is obtained by cutting a cylinder along its longitudinal axis. One of axial ends of the cover is supported by the function portion, and the light source is housed in the cover. An area of the cover sandwiched between its edges is opened. The light source is exposed downwardly while the opening is oriented downward.

Because of this structure, there is a possibility in that the light source cannot be protected against physical shock inflicted on the interior of the opening of the cover during transport.

A light source protective member (cover) of the lamp unit (the vehicle interior lighting) described in PTL 2 includes a cover body continually connected to a light source drive section (a function portion) so as to cover surroundings of the light source and a lid portion that is provided on the cover body and that opens when the light source drive section is attached to a design member (the design portion) in such a way that the light source becomes exposed toward a passenger compartment.

Because of the structure, when the light source drive section is attached to the design member, the light source drive section must be attached while the lid portion made up of a pair of doors which are reclosably attached to the cover body remains open and while engagement portions, like a pair of claws, provided at respective ends of the doors are engaged with a wall surface or the design member. Thus, the light source protective member encounters a possibility of deterioration of ease of assembling work.

The present invention has been conceived in light of the circumstances. And an object of this invention is to provide a vehicle interior lighting that protects a light source from external force during transport or in the course of the light source being assembled to a vehicle and that can enhance ease of assembling work.

The object of the present invention is accomplished by the following configurations (1), (2) and (3).

(1) A vehicle interior lighting configured to be attached to a lamp attaching hole formed in an interior wall member of a vehicle, comprising:

a design portion configured to be disposed on a passenger compartment side of the interior wall member; and

a function portion configured to be disposed in an outdoor side of the interior wall member and to be attached to the lamp attaching hole, the function portion including a housing having an opening opened to the passenger compartment side and a light source accommodation portion accommodating and holding a light source and a light source protective portion provided with the housing so as to cover the opening;

wherein the light source protective portion has a light passing aperture having a size for preventing the light source from contacting an external member.

In the vehicle interior lighting described in connection with (1), the opening of the housing that is opened to the passenger compartment side is covered with the light source protective portion having the light passing aperture of size for preventing the light source from contacting an external member. Accordingly, when the function portion is transported with the design portion being unattached, another member or an external member, like a finger or a hand, cannot contact the light source. When only the function portion is assembled into the lamp attaching hole of the interior wall member with the design portion being unattached, the function portion can be assembled into the lamp attaching hole with the light source protective portion being attached to the opening of the housing. Hence, assembly work becomes easy, and neither a finger nor a hand will contact the light source.

(2) In the vehicle interior lighting described in connection with (1), an inner peripheral wall of the light source protective portion that defines the light passing aperture has a tapered surface aligned to a light ray of light irradiated from the light source.

In the vehicle interior lighting described in connection with (2), the light irradiated from the light source of the light source accommodation portion will not be blocked (shielded) by the inner peripheral wall of the light source protective portion that defines the light passing aperture more than necessity when the light irradiated by the light source in the light source accommodation portion passes through the light passing aperture of the light source protective portion, because the inner peripheral wall of the light passing aperture is made up of a tapered surface aligned to a light ray of the irradiated light. As a result, deterioration of light use efficiency due to presence of the light source protective portion having the light passing aperture is minimized.

(3) In the vehicle interior lighting described in connection with (1) or (2), the light source protective portion is reclosable with respect to the opening by way of a hinge.

In the vehicle interior lighting described in connection with (3), the light source protective portion can be molded integrally with the housing by way of the hinge, so that the number of components becomes small. Accordingly, component management becomes easy, and manufacturing costs become inexpensive. During assembly work and replacement of the light source, loss of the light source protective portion can be prevented.

The vehicle interior lighting of the present invention can protect the light source from external force during transport or when the light source is assembled to a vehicle and enhance ease of assembling work.

The present invention has been briefly described thus far. Details of the present invention will be more clarified by through-reading of a mode for implementing the present invention to be described below (hereinafter referred to as an “embodiment”) with reference to the accompanying drawings.

### BRIEF DESCRIPTION OF THE DRAWINGS

FIG. 1A is a perspective view of an entire vehicle interior lighting of an embodiment of the present invention, and FIG. 1B is an exploded perspective view of the vehicle interior lighting showing that a design portion is removed from a function portion;

FIG. 2 is an exploded perspective view showing that a light source protective portion of the function portion shown in FIGS. 1A and 1B is opened;

FIG. 3 is an explanatory view of assembly procedures employed after mounting of a light source of the function portion shown in FIG. 2;

FIG. 4 is an explanatory view of assembly procedures showing operation performed in the course of closing of the light source protective portion of the function portion shown in FIG. 3;

FIG. 5 is an explanatory view of assembly procedures employed before connection of an electric wire to the function portion shown in FIG. 4;

FIG. 6 is an explanatory view of procedures employed after the electric wire of the function portion shown in FIG. 5 is inserted into a lamp attachment hole and connected to a wire harness of a vehicle;

FIG. 7 is an explanatory view of procedures employed after a design portion is attached to the function portion attached to the lamp attachment hole;

FIGS. 8A and 8B are explanatory views of procedures employed immediately before assembly of the vehicle interior lighting shown in FIG. 7;

FIG. 9A is a cross sectional view of the vehicle interior lighting attached to an interior wall member when observed in direction A-A shown in FIG. 8B, and FIG. 9B is an enlarged view of principal sections shown in FIG. 9A; and

FIG. 10A is a cross sectional view showing that a related-art vehicle interior lighting is attached to an opening of an interior wall member, and FIG. 10B is a perspective view of a function portion achieved before attachment of a light source protective cover.

### DETAILED DESCRIPTION OF THE EXEMPLARY EMBODIMENTS

A vehicle interior lighting of an embodiment of the present invention is hereunder described in detail by reference to the accompanying drawings.

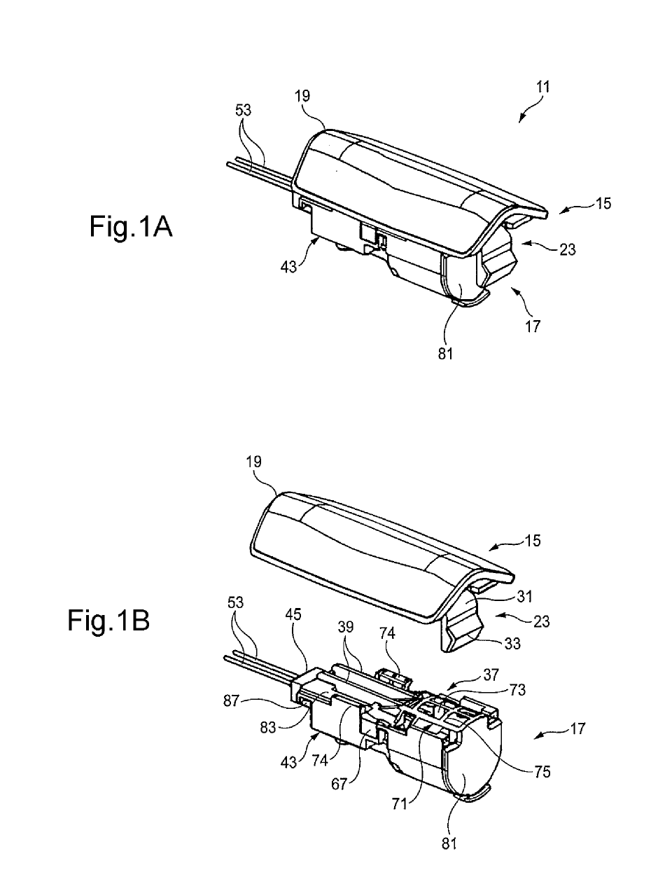

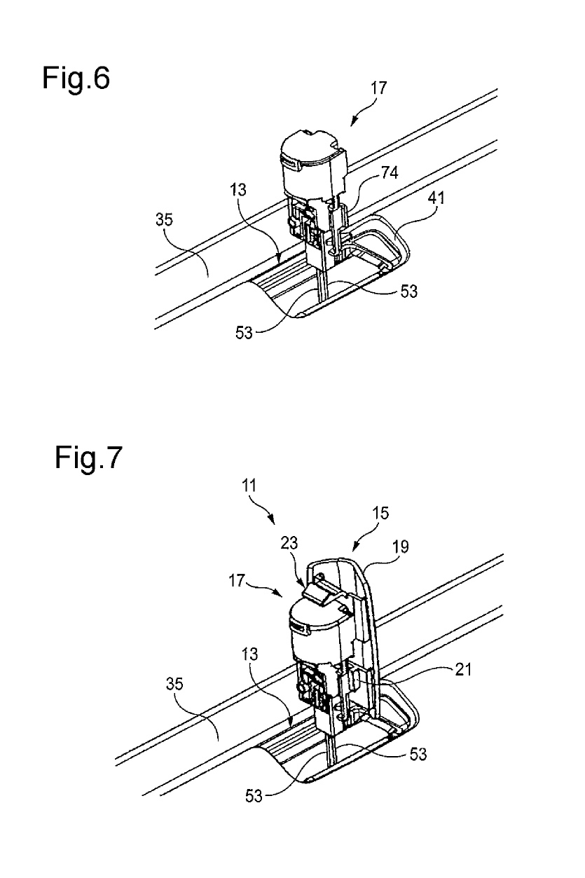

A vehicle interior lighting 11 of the present embodiment shown in FIGS. 1A and 1B is a courtesy lamp attached to a lamp attachment hole 13 (see FIG. 6) opened in a door trim 35 that is an interior wall member of a vehicle. The vehicle interior lighting 11 is configured by a design portion 15 and a function portion 17. The design portion 15 is placed on a passenger compartment side of the door trim 35 and has a lens 19 (see FIG. 7), a lock section 21 (see FIG. 7), and an interior wall member engagement claw 23 (see FIG. 7).

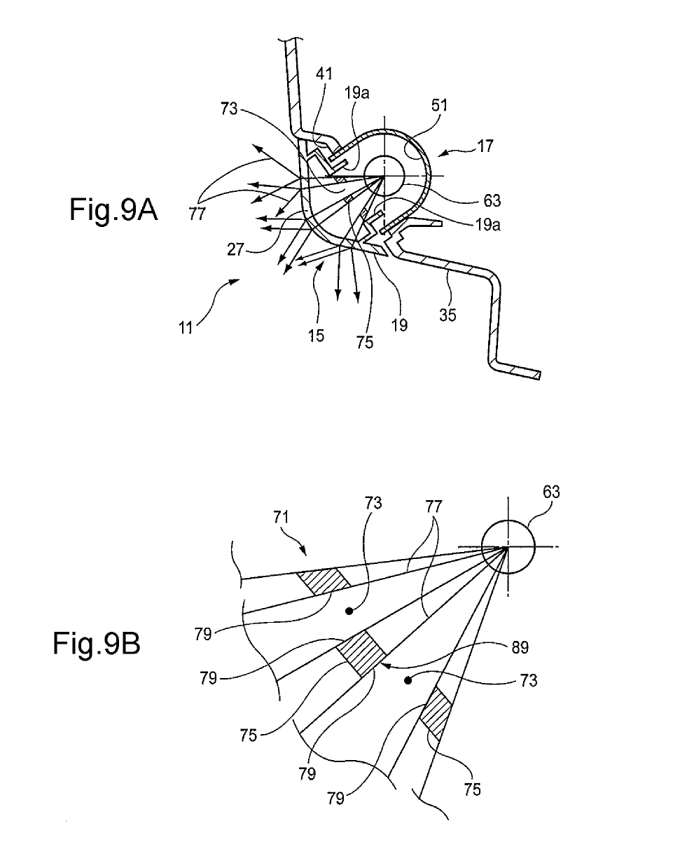

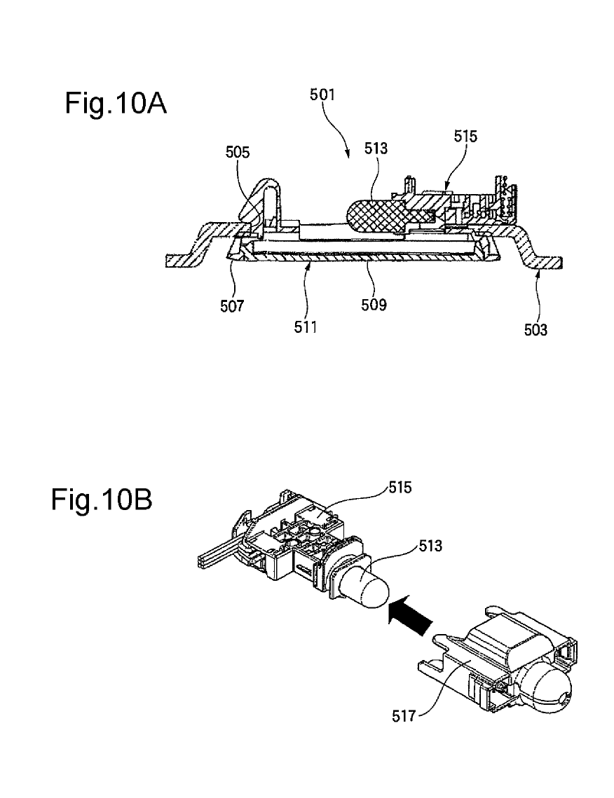

The lens 19 is formed from a light transmissive transparent resin material and formed into a shape obtained by bending a substantially rectangular plate to its one surface side. A pair of light-shielding pieces 19a that is shown in FIG. 9A is protruded on a concave side (an outdoor side) of the lens 19. The light-shielding pieces 19a prevent leakage of light originated from a bulb 63 that is a light source from clearance of the attachment between the lamp attachment hole 13 and the vehicle interior lighting 11. Furthermore, light diffusion means 27 is formed in the lens 19. An appropriate geometry of a lens cut, an embossed surface, or the like, can be used as the light diffusion means 27.

The lock section 21 is projectingly provided as a pair of parallel elastic engagement pieces on the concave surface side of the lens 19. The lock section 21 is elastically, releasably engaged with engagement sections 74 provided on both sides of the function portion 17. As a result of the lock section 21 provided on the lens 19 being engaged with the engagement sections 74 of the function portion 17, the design portion 15 is integrally assembled into the function portion 17 as shown in FIG. 1A.

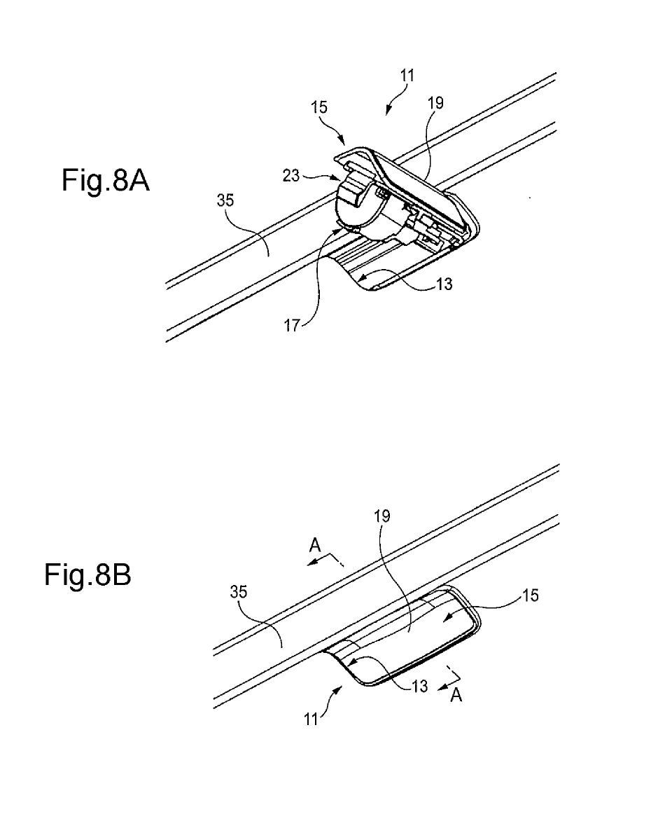

The interior wall member engagement claw 23 is projectingly provided on the concave surface side of one of the longitudinal ends of the lens 19. The interior wall member engagement claw 23 has an engagement claw 33 at a leading end of a strip-shaped elastic plate 31 and is engaged with a back of the door trim 35 (see FIGS. 8A and 8B). Coordinating with engagement ribs 39 (see FIG. 5) of a light source protective portion 37 to be described later, the interior wall member engagement claw 23 lets the vehicle interior lighting 11 into which the design portion 15 and the function portion 17 are integrated, fixedly engage with the lamp attaching hole 13 of the door trim 35 such that the lens 19 becomes substantially flush with a surface of the door trim 35.

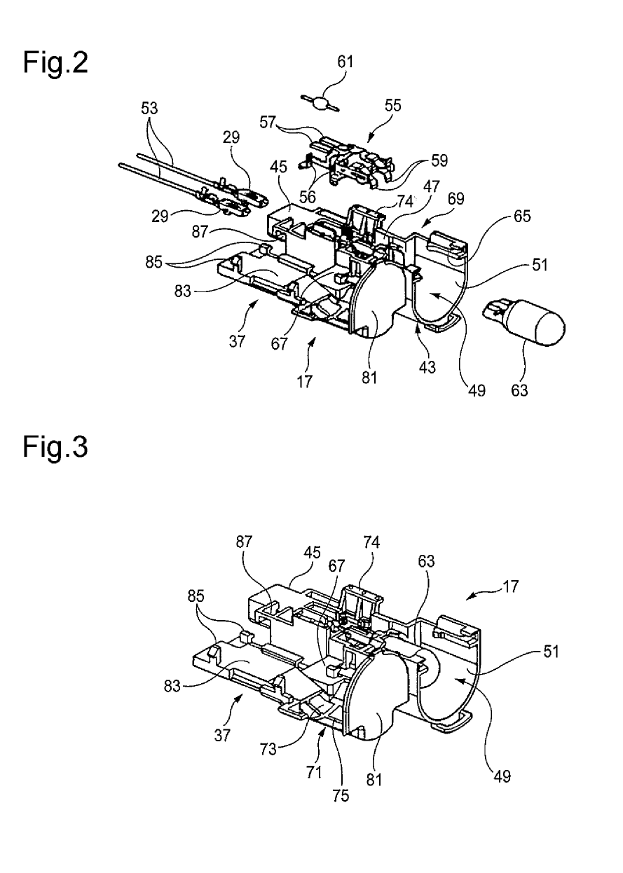

The function portion 17 is disposed on an outdoor side of the door trim 35 and attached to the lamp attaching hole 13. The lamp attaching holed 13 is formed into an indented edge 41 (see FIG. 6) formed in the door trim 35. The function portion 17 has a housing 43 shown in FIGS. 1A and 1B. As shown in FIG. 2, the housing 43 includes a lead-out wire section 45, a bus-bar accommodation portion 47, a light source accommodation portion 49, and a reflector 51 that are, in this sequence from one end, continued and connected. An electric wire 53 connected to a terminal 29 is led out of the lead-out wire section 45. The terminal 29 is connected to an electrical contact 57 of a bus-bar 55 accommodated in the bus-bar accommodation portion 47. An un-illustrated lance provided in the lead-out wire section 45 prevents the terminal 29 connected to the electrical contact 57 from falling.

Bulb contacts 59 to be connected to the bulb 63 are formed on the bus-bar 55. Press contact blades 56 are formed in the bus-bar 55 and exert press contact to a diode 61 used for making up a light source circuit. A die bar cut part is formed in the bus-bar 55, and the bus-bar 55 can cope with presence/absence of the diode 61 by cutting the die bar cut part.

The light source is not limited to the bulb 63 having a filament, but an LED can also be used. The bulb 63 is attached into the light source accommodation portion 49 and activated to thus emit light as a result of the light source circuit made up of the bus-bar 55 and the diode 61 being fed with electric power by way of the electric wire 53.

The reflector 51 is formed into a shape of a concave surface. A reflecting surface is formed over an inner periphery side of the reflector by; for instance, aluminum deposition. The bulb 63 is disposed at a center of the reflector 51. The reflector 51 has the concave reflecting surface and reflects outgoing light originated from the bulb 63 toward a reflector opening 65 with superior efficiency. In addition to enhancing light use efficiency of the bulb 63, the reflector 51 prevents occurrence of light leakage, which would otherwise occur when the light temporarily leaked to a back of the door trim 35 wraps around the same to the passenger compartment. The reflector 51 also prevents fusing of the electric wire 53, which would otherwise occur when the electric wire 53 contacts the bulb 63.

Incidentally, the light source protective portion 37 having a plurality of light passing apertures 73 is joined to the housing 43 so as to be reclosable to a passenger-compartment-side opening 69 of the housing 43 that is opened to the passenger-compartment-side by a thin hinge 67. The light source protective portion 37 can be molded integrally with the housing 43 by the thin hinge 67. Specifically, the light source protective portion 37 can become molded integrally with the housing 43 by the thin hinge 67, so that the number of components is reduced. Accordingly, component management becomes easier, and manufacturing costs become inexpensive. Moreover, loss of the light source protective portion 37 can be prevented at the time of assembly of the function portion 17 or replacement of the bulb 63.

A grid-like section 71 having the plurality of light passing apertures 73 shown in FIG. 1B is formed in the light source protective portion 37. The grid-like section 71 is placed so as to cover the reflector opening 65 when the light source protective portion 37 closes the passenger-compartment-side opening 69 of the housing 43. Accordingly, the grid-like section 71 that is built from the plurality of rectangular light passing apertures 73 defined as a result of crosspieces 75 being arranged in a matrix pattern covers the reflector opening 65, thereby hindering the bulb 63 from contacting another member or an external member, like a hand and a finger. An area of each of the light passing apertures 73 of the grid-like section 71 is of a size that prevents a finger or a hand from entering the aperture. This is intended for preventing fingers from erroneously contacting the bulb 63 during assembly work.

Other example modifications of the light source protective portion 37 include a light source protective portion including circular light passing apertures 73 and a light source protective portion including staggered light passing apertures 73. As to the light passing apertures 73, a plurality of slit-like apertures each of which has a small width may also be employed. Alternatively, for instance, a punched plate in which the circular light passing apertures 73 are staggered can also be used. As will be described later, an inner peripheral wall 89 of each of the light passing apertures 73 has a tapered surface 79 aligned to a light ray 77 (see FIGS. 9A and 9B) of irradiated light.

As shown in FIG. 2, a vertical closure plate 81 that closes an end of the reflector opening 65 is formed at the grid-like section 71 of the light source protective portion 37. When the light source protective portion 37 closes the passenger-compartment-side opening 69 of the housing 43, the vertical closure plate 81 closes an end of the reflector opening 65 on a leading end side of the function portion 17.

As shown in FIG. 2, the light source protective portion 37 has a bus-bar accommodation portion closure plate 83 continually provided opposite the vertical closure plate 81 with the grid-like section 71 sandwiched therebetween. A pair of parallel claws 85, are projectingly provided on the bus-bar accommodation closure plate 83. The claws 85 are engaged with respective engagement frames 87 provided on both sides of the housing 43, whereby the light source protective portion 37 is retained by the housing 43 in a closed fashion. Further, the pair of parallel engagement ribs 39 are provided on a surface of the bus-bar accommodation closure plate 83. Engagement spacing exists between the engagement ribs 39 and the bus-bar accommodation portion closure plate 83. The engagement ribs 39 retain an edge of the lamp attaching hole 13 of the door trim 35 in the engagement spacing. Specifically, the engagement ribs 39 are engaged with one end side of the lamp attaching hole 13, and the interior wall member engagement claw 23 is engaged with the other end of the lamp attaching hole 13, whereby the vehicle interior lighting 11 is attached to the door trim 35.

Procedures for assembling the vehicle interior lighting 11 having the above configuration are now describe by reference to FIGS. 2 to 5.

Before transport of the vehicle interior lighting 11, the function portion 17 is assembled. In order to assemble the function portion 17, the bus-bar 55 is first press-attached to the bus-bar accommodation portion 47 shown in FIG. 2. The bus-bar 55 is subjected to die bar cutting as appropriate. The diode 61 is press-attached into the bus-bar 55 accommodated in the bus-bar accommodation portion 47.

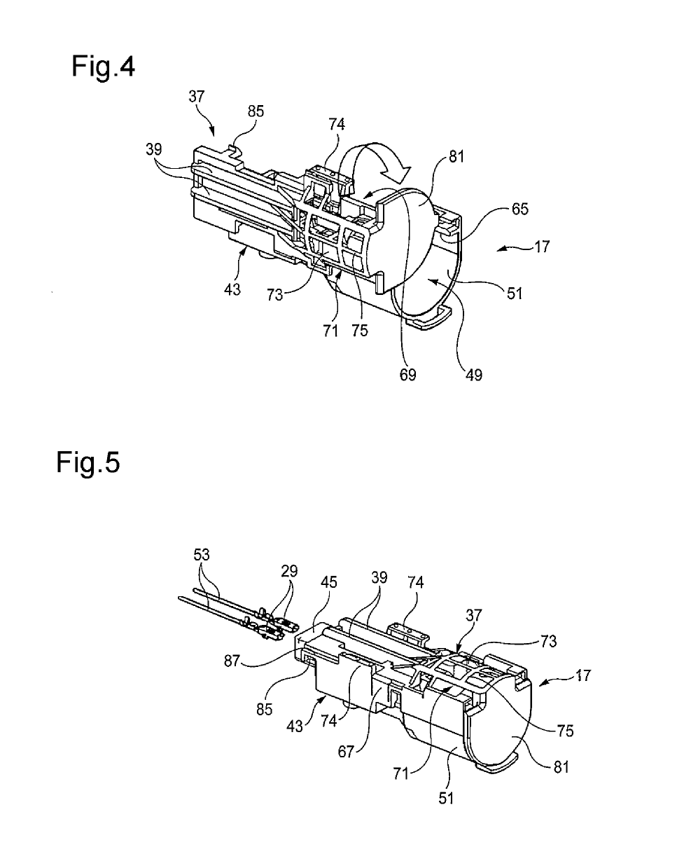

Next, as shown in FIG. 3, the bulb 63 is inserted into the light source accommodation portion 49. As shown in FIG. 4, the light source protective portion 37 is turned around the thin hinge 67, thereby bringing the claws 85 into engagement with the respective engagement frames 87. Thus, the passenger-compartment-side opening 69 of the housing 43 is closed by the light source protective portion 37. The reflector opening 65 is thereby covered with the grid-like section 71 having the plurality of light passing apertures 73.

As shown in FIG. 5, the electric wire 53 connected to the terminal 29 is connected to the housing 43 in which the reflector opening 65 is protected by the light source protective portion 37. Assembly of the function portion 17 is thereby completed, so that the vehicle interior lighting 11 becomes transportable.

Procedures for assembling the thus-built function portion 17 to a vehicle are now described by reference to FIGS. 6 to 8.

In relation to the vehicle interior lighting 11, the function portion 17 to which the design portion 15 is not yet attached is attached to the lamp attaching hole 13 of the door trim 35. In the function portion 17 attached into the lamp attaching hole 13, the lead-out electric wire 53 is connected to a wire harness of the un-illustrated vehicle on the back of the door trim 35.

Next, as shown in FIG. 7, the design portion 15 including the lens 19 as a primary member is attached to the function portion 17 by the engagement section 21. As shown in FIG. 8A, in the vehicle interior lighting 11 in which the design portion 15 is integrally attached to the function portion 17, the engagement rib 39 of the function portion 17 (see FIG. 4) is engaged with an edge on one end of the lamp attaching hole 13. Subsequently, the interior wall member engagement claw 23 of the design portion 15 is engaged with an edge on the other end of the lamp attaching hole 13.

As shown in FIG. 8B, in the thus-mounted vehicle interior lighting 11, the design portion 15 is attached to the lamp attaching hole 13, thereby closing the lamp attaching hole 13 with superior appearance in such a way that the lens 19 substantially becomes flush with the surface of the door trim 35. Assembling the vehicle interior lighting 11 to the door trim 35 is thereby completed.

As above, in the vehicle interior lighting 11 of the present embodiment, when the function portion 17 is transported with the design portion 15 being unattached, the passenger-compartment-side opening 69 of the housing 43 is covered with the light source protective portion 37 having the plurality of light passing apertures 73, so that another member or an external member, like a finger or a hand, cannot contact the bulb 63. Moreover, when only the function portion 17 is attached to the lamp attaching hole 13 of the door trim 35 with the design portion 15 being unattached, the function portion 17 can be attached into the lamp attaching hole 13 while the light source protective portion 37 remains attached to the passenger-compartment-side opening 69 of the housing 43, so that assembly work becomes easy, and a finger or a hand does not contact the bulb 63.

As shown in FIGS. 9A and 9B, the inner peripheral wall 89 (an external wall of each of the crosspieces 75) of each of the plurality of light passing apertures 73 making up the grid-like section 71 in the light source protective portion 37 has the tapered surface 79 aligned to the light ray 77 of the light irradiated by the bulb 63. Accordingly, even when the light irradiated by the bulb 63 passes through the plurality of light passing apertures 73 while the light source protective portion 37 remains attached to the passenger-compartment-side opening 69, the light irradiated by the bulb 63 is not blocked (shielded) by the crosspieces 75 existing between the light passing apertures 73 beyond necessity, because the inner peripheral wall 89 of each of the light passing apertures 73 is made up of the tapered surface 79 aligned to the light ray 77 of the irradiated light. A drop in light use efficiency resultant of presence of the light source protective portion 37 having the plurality of light passing apertures 73 in the passenger-compartment-side opening 69 of the light source accommodation portion 49 is thereby minimized.

Moreover, the lens 19 of the present embodiment is provide with the light diffusion means 27. The light diffusion means 27 diffuses the outgoing light from the bulb 63, so that a shadow, which would otherwise be caused by the crosspieces 75 of the light source protective portion 37 making up the plurality of light passing apertures 73, can be prevented from emerging in the irradiated light.

Accordingly, in the vehicle interior lighting 11 of the present embodiment, the bulb 63 is protected from external force which will be exerted during transport or assembling the vehicle interior lighting 11 to a vehicle, and ease of assembly work can be enhanced.

Needless to say, the configuration of the vehicle interior lighting of the present invention, like the interior wall member, the design portion, the function portion, the housing, the light source protective portion, and so on, is not limited to the configuration of the embodiment, and various modes can be adopted in compliance with the gist of the present invention.

For instance, in the embodiment, the vehicle interior lighting 11 has been described by taking, as an example, a courtesy lamp attached into the lamp attaching hole 13 formed in the door trim 35. However, it goes without saying that the vehicle interior lighting of the present invention can be applied to various interior lightings, like a dome lamp and a map lamp.

In the embodiment, the light source protective portion 37 having the plurality of light passing apertures 73 has been described. However, so long as a light source protective portion having one light passing aperture is formed, the light source protective portion can also be applied, as a matter of course, to; for instance, a vehicle interior lighting that emits spot light.

What is claimed is:

1. A vehicle interior lighting configured to be attached to a lamp attaching hole formed in an interior wall member of a vehicle, comprising:
a design portion configured to be disposed on a passenger compartment side of the interior wall member; and
a function portion configured to be disposed in an outdoor side of the interior wall member and to be attached to the lamp attaching hole, the function portion including a housing having an opening opened to the passenger compartment side and a light source accommodation portion accommodating and holding a light source and a light source protective portion provided with the housing so as to cover the opening;
wherein the light source protective portion has a light passing aperture having a size for preventing the light source from contacting an external member.

2. The vehicle interior lighting according to claim 1, wherein an inner peripheral wall of the light source protective portion that defines the light passing aperture has a tapered surface aligned to a light ray of light irradiated from the light source.

3. The vehicle interior lighting according to claim 1, wherein the light source protective portion is reclosable with regard to the opening via a hinge.
